(19) United States
(12) Patent Application Publication
(10) Pub. No.: US 2018/0082024 A1
(43) Pub. Date: Mar. 22, 2018

(54) Secure Distributed Patient Consent and Information Management

(71) Applicant: International Business Machines Corporation, Armonk, NY (US)

(72) Inventors: Francisco P. Curbera, Hastings On Hudson, NY (US); Shahram Ebadollahi, White Plains, NY (US); Maria Eleftheriou, Mt. Kisco, NY (US); Ramesh Gopinath, Millwood, NY (US); Krishna C. Ratakonda, Yorktown Heights, NY (US); Paul C. Tang, Los Altos, CA (US)

(21) Appl. No.: 15/672,443

(22) Filed: Aug. 9, 2017

Related U.S. Application Data
(60) Provisional application No. 62/395,838, filed on Sep. 16, 2016.

(51) Int. Cl. G06F 19/00

(52) U.S. Cl. CPC G06F 19/322; G06F 21/6245; G06F 19/3418

(57) ABSTRACT

Mechanisms are provided for executing patient information transactions. The mechanism store, in a ledger storage system, for each patient, a history of patient consents associated with patient transactions in a healthcare network, comprising patient consent data structures associated with the patient information transferred between participants as part of the transaction. The mechanisms store a master patient record index (MPRI) for each of the patients. The MPRI stores record locators identifying locations of portions of patient information for the patient on different computing devices associated with different health providers. The mechanisms execute, by a transaction manager, a transaction to grant access to a portion of a patient's information based on consent information stored in the ledger storage system and record locators in the MPRI. The mechanisms update, by a ledger storage engine of the data processing system, the history of transactions based on the execution of the transaction.

### BACKGROUND

The present application relates generally to an improved data processing apparatus and method and more specifically to mechanisms for managing distributed patient consent and patient information in a secure and compliant manner.

Efficient access to electronic medical records (EMRs) by authorized parties, such as physicians, researchers, and the like, is expected to generate significant benefits in the quality and value of the care delivered by health providers and is expected to lead to more efficient health delivery systems. This goal has become a priority for government organizations and most participants in the health industry. Many efforts are underway to create the infrastructure and the mechanisms required to achieve this goal including health information exchanges, interoperability standards etc.

Much emphasis has been placed so far on enabling technical and semantic interoperability between competing vendors of health services and health products, and the health providers. However, societal concerns related to protection of privacy of patient's medical records remains high and constitute a major factor limiting a more open exchange of medical information. At the same time, a health provider's need to maintain compliance with legal requirements, such as (Health Insurance Portability and Accountability Act (HIPAA) regulations and the protection of conditions considered sensitive (such as mental health, substance abuse, HIV/AIDs, etc.), result in inefficient, burdensome processes that limit or slow the release of medical information to authorized users.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided for executing patient information transactions based on a security protected transaction ledger. The method comprises storing, by a data processing system, in a ledger storage system, for each patient, a history of patient consents associated with patient transactions in a healthcare network, comprising patient consent data structures associated with the patient information transferred between participants as part of the transaction. The method further comprises storing, by the data processing system, a master patient record index (MPRI) for each of the patients, wherein the MPRI stores record locators identifying locations of portions of patient information for the patient on different computing devices associated with different health providers. In addition, the method comprises executing, by a transaction manager of the data processing system, a transaction to grant access to a portion of a patient's information based on consent information stored in the ledger storage system and record locators in the MPRI. Moreover, the method comprises updating, by a ledger storage engine of the data processing system, the history of transactions based on the execution of the transaction.

In some illustrative embodiments, the ledger storage system implements a blockchain methodology for storing the history of transactions. The blockchain methodology provides an immutable record of the transactions.

In other illustrative embodiments, the ledger storage system stores transactions that comprise consent information associated with patient information that either grants access to the patient information to a health provider, denies access to the patient information to the health provider, or revokes a previous grant of access to the patient information to the health provider. In this way, a historical record of patient consents, consent denials, and revocations of consent may be maintained for use in performing consent audits, for example.

In some illustrative embodiments, the method further comprises receiving a request from a patient computing device to view patient information and consent information associated with the patient information, and outputting the patient information for the patient in association with consent information associated with the patient information to the patient computing device for review and/or modification. In this way, the patient is able to view their consent information and the patient information with which the consent information is associated so that the patient is able to make modifications to this consent information if desired.

In some illustrative embodiments, executing, by a transaction manager of the data processing system, a transaction to grant access to a portion of a patient's information based on consent information stored in the ledger storage system and record locators in the MPRI comprises: distributing, to a plurality of node devices of a validation network, a request for validation of the transaction; and receiving a response from the plurality of node devices indicating whether or not the transaction is validated, wherein the transaction is executed by the transaction manager only if the response from the plurality of node devices indicates that the transaction is validated. In this way, a distributed validation network may be used to determine whether or not to grant a transaction or not thereby reducing the likelihood that a transaction of patient information occurs erroneously.

In some illustrative embodiments, receiving a response from the plurality of node devices indicating whether or not the transaction is validated comprises: performing, at each node device in the plurality of node devices, a validation of the transaction based on a blockchain consensus protocol; and generating a response from the plurality of node devices based on results of validation of the transaction by each of the node devices, wherein the response from the plurality of node devices is a denial of the request if any one of the node devices does not indicate the transaction to be validated. In this way, a consensus approach is used to determine whether to grant the transaction or not, with a blockchain consensus protocol being utilized to thereby reduce the likelihood of erroneous transactions of patient information.

In some illustrative embodiments, the transaction is executed by the transaction manager at least by: retrieving a record locator from the MPRI, that identifies a location of the portion of the patient's information on a first participant device; and providing the record locator to a second participant device as part of the transaction of patient information to facilitate performance of the transaction by the second participant device. In some illustrative embodiments, the first participant device is a wearable health monitoring device associated with the patient.

In still other illustrative embodiments, executing, by a transaction manager of the data processing system, a transaction to grant access to a portion of a patient's information based on consent information stored in the ledger storage system and record locators in the MPRI comprises performing a de-identification operation on the portion of the patient's information to remove any patient identifiers from the patient information prior to executing the transaction. In this way, the patient's identity is maintained secure when providing the patient information as part of the transaction.

In other illustrative embodiments, updating the history of transactions based on the execution of the transaction comprises: logging the transaction in an append only ledger record of a ledger storage; logging, in the ledger storage, a consent log, wherein the consent log comprises immutable consent records, and wherein the consent records comprise consent documents or data structures indicating consent provided or revoked by the patient, and the particular entities to which consent has been provided or revoked by the patient, for accessing the portion of the patient's information; and generating a full consent audit log of the transaction based on the append only ledger record and consent log. In this way, immutable logs of consent are maintained for use in generating consent audits.

In another illustrative embodiment, a method is provided, in a data processing system, for executing patient information transactions based on a tamper-proof immutable transaction ledger. The method comprises storing, by the data processing system, in a ledger storage system, for each patient, a history of transactions of patient information between participants in a healthcare network. Each transaction in the history of transactions comprises patient consent data structures associated with the patient information transferred between participants as part of the transaction. The method further comprises storing, by the data processing system, a master patient record index (MPRI) for each of the patients. The MPRI stores record locators identifying locations of portions of patient information for the patient on different computing devices associated with different health providers. Moreover, the method comprises executing, by a transaction manager of the data processing system, a transaction to grant access to a portion of a patient's information based on consent information stored in the ledger storage system and record locators in the MPRI. In addition, the method comprises updating, by a ledger storage engine of the data processing system, the history of transactions based on the execution of the transaction.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one example cognitive data processing system environment in which aspects of the illustrative embodiments may be implemented;

FIG. 2 provides a functional block diagram of a distributed patient CIMS that illustrates the interaction of components in accordance with one illustrative embodiment;

FIGS. 3-5 provide example scenarios to illustrate interactions between patients and health providers that are facilitated by the mechanisms of the illustrative embodiments; and

FIG. 6 is a block diagram of an example data processing system in which aspects of the illustrative embodiments are implemented.

### DETAILED DESCRIPTION

The illustrative embodiments of the present invention provide mechanisms that implement secure distributed patient consent and patient information management which address the competing needs in the health care industry for efficient access to electronic medical records by authorized parties while maintaining protection of privacy of patient health related information and complying with governing regulations. The mechanisms of the illustrative embodiments implement an improved form of blockchain technology to manage patient consent information and distribution of patient information based on the patient consent information, i.e. the patient information or patient data always follows the patient consent information and records of transactions and their associated consents are maintained in a tamper-proof and immutable blockchain data structure. This improved blockchain mechanism operates in conjunction with a master patient record index (MPRI) component to enable the exchange of data (patient information) among health providers once consent has been granted by the patient. Only those entities for which a patient consent electronic document or data structure indicates consent has been granted, will be able to be given a record locator that identifies the location of a particular portion of patient information. Once provided with a record locator from the MPRI, the entity can directly request patient information from another entity, where the patient information resides as indicated by the record locator, or the mechanisms of the illustrative embodiments may operate as an intermediary data hub with regard to secure information transfer, depending on the desired implementation.

With the mechanisms of the illustrative embodiments, many benefits and use cases are enabled that provide significant advantages over existing mechanisms. For example, using the improved blockchain and index mechanisms of the illustrative embodiments, patients are always able to determine where their patient information resides and to whom the patient has granted access, and to what portions of the patient information access was granted. This further permits distributed storage of the patient's information rather than having to have a centralized repository, e.g., the various health providers may maintain their own portion of the patient's information and provide it as needed, and as consented to by the patient, to other health providers on-demand. In addition, since consents are tied to the patient information, and may specify individual portions of the patient information, such as through segmentation of the patient information, a more fine grained control of the accesses to, and dissemination of, portions of the patient information is made possible, e.g., a podiatrist may not need to be able to access the patient's psychological records and thus, the patient may not consent to the podiatrist's access of such information. In addition, patient information to which a health provider has not been given access through patient consent documents or data structures, may be denied access to such information, or automated mechanisms may be implemented for de-identifying, anonymizing, or otherwise obfuscating the portions of the patient information that the health provider does not have consent to access.

Secure distributed ledger technologies such as blockchain, where identical and tamper-proof copies of the ledger are maintained but a number of independent parties, provide a higher level of trust than single ‘trusted third party’ solutions, assuring patients and providers that they will receive and can act on valid, secure, fully trusted information. Furthermore, through the blockchain or other ledger based mechanisms of the illustrative embodiments, a persistent immutable store of transactions of patient information, linking consents with the patient information being transacted and the entities involved in the transaction is provided. In some cases the consents may be for de-identified data, such as for patient information being provided to a research facility. In such cases, current laws permit reuse of such de-identified data, however personal identifiers are removed from the data at the point of use making this a repetitive process. The illustrative embodiments support the ability to remove personal identifiers from patient information in accordance with consents, and replace the information with a tag that indicates the removal, such as a “no longer identified” tag, and certification under consents may be done once and registered in the blockchain or ledger, enabling free exchange of de-identified data patient information without repetitive de-identifying operations.

Existing mechanisms for managing patient consent are cumbersome, lack flexibility, or provide low levels of trust to patients. With such existing mechanisms, a strong reliance on “implicit” access permission grants within and across health systems often results in a model for using patient consent as a blanket access permission. To the contrary, as set forth hereafter, the illustrative embodiments address the limitations of existing mechanisms by providing an efficient, flexible mechanism that patients can trust and which gives them full control over their patient information while, at the same time, streamlining the exchange of medical information among authorized providers and providing them with compliance guarantees.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the present invention provides mechanisms that implement an improved block chaining approach to manage the distribution of patient consent and patient information which affords flexibility and control to patients over their personal patient medical information, while providing efficient access to patient medical information by authorized personnel in a manner that complies with governmental regulations. The mechanisms of the illustrative embodiments utilize an improved form of blockchain technology to assist with providing a secure distribution of patient consent and patient information. In the context of the present invention, patient information (or data) may comprise any demographic information, personal information such as may be in a patient profile, clinical information, and/or health information. Clinical information comprises more formal medical information generated by medical professionals and medical facilities when examining, diagnosing, or treating the patient. Health information comprises less formal medical information that covers various aspects of the patient's overall health and may come from various monitoring devices, e.g., wearable health monitoring devices such as FitBit™, pedometers, smart weight scales, various applications to track lifestyle information such as food trackers, exercise trackers, etc.

Blockchain technology, also referred to herein as “blockchaining”, involves the creation of a ledger of transactions, referred to as a blockchain, that may be relied upon by the parties involved in the transactions as a secure representation of the transactions that occurred. That is, a blockchain is a data structure that makes it possible to create a digital ledger of transactions and share the digital ledger among a distributed network of computers. Blockchain technology uses cryptography to allow each participant on the network of computers to manipulate the ledger in a secure way without the need for a central authority. Once a block of data is recorded on the blockchain ledger, it is extremely difficult to change or remove. When something is to be added to the blockchain ledger, participants in the network, all of which have copies of the existing blockchain data structure, run algorithms to evaluate and verify the proposed transaction. If a majority of the participants agree that the transaction is valid, i.e. identifying information matches the blockchain's history, then the new transaction will be approved and a new block added to the blockchain.

Blockchain technology has been provided by the company Guardtime, to the country of Estonia for use in their nationwide healthcare system, eEstonia. Healthcare data from different providers in the system is electronically linked thru a federated model, creating a virtual record for each patient. A blockchain-like based system (Guardtime) uses a hash metadata protocol to keep track of record integrity and updates across the system. The Guardtime system also uses a protocol (Xroad) to connect distributed databases and provide data sharing. While this system may provide a blockchain-like system, the eEstonia system does not implement a notion of a patient providing a patient consent granting contract because healthcare record assets cannot be transferred under the eEstonia system. Moreover, the eEstonia system does not address privacy concerns of patients as the blockchain-like system is focused on simply providing an integrity mechanism instead. The eEstonia and Guardtime system do not provide a mechanism for consensus validation of transactions.

In the United States of America, and other countries, there is a major trend to facilitate the exchange of health records across health service and health product providers (collectively referred to herein as “health providers”), where such health providers may be individual professionals, for example, physicians, nurse practitioners, medical technicians, pharmacists, pharmacy workers, laboratory workers, etc., or organizations, such as hospitals, pharmacies, laboratories, health insurance companies, governmental health organizations, health product providers, or any other provider of patient health services, pharmaceuticals, health related equipment, or other types of health related products. While not always fully endorsed by electronic medical record (EMIR) system vendors, government agencies at different levels use legal, regulatory and funding mechanisms to enable different medical record exchange technologies.

Health information exchanges (HIEs) enable the electronic exchange of medical information among care providers, either directly, with patient mediation, or based on a specific query for information. The HIE effort has focused on enabling the standards, technology and policies required to support information exchanges. HIEs often assume a set of policies governing the allowable exchange of medical information, but do provide explicit tracking of individual exchanges to patient consent. HIEs, however, do not provide an infrastructure to manage patient consent across the various systems that contribute to the HIE. To the contrary, patient consent is maintained within each individual health providers and often in paper form only.

There is significant activity among health service and product vendors with regard to developing technologies to streamline health information exchanges (HIEs) and establish interoperability and standards agreements. For example, vendors are exploring the use of new technologies such as cloud based systems and cloud connectivity, in support of medical record information exchanges. One example of such a cloud based solution is provided by RelayHealth. Other technologies being explored, such as by Athenahealth with their AthenaText application, or “app”, that allows health providers to exchange patient information via texting in real time and which enables HIPPA-compliant information exchange between health providers.

However, none of these solutions offers mechanisms that provide a trusted, distributed way to manage consent and tie record exchange activity to patient authorization. Moreover, these solutions are focused on access to formal clinical records, and not yet able to support exchange of the great variety of health information that is already available from non-traditional sources, such as personal devices, wearables, and new healthcare solution providers.

The illustrative embodiments provide a distributed patient consent and information management system (CIMS) which is a distributed system connecting patients, health providers, and other participants in the healthcare ecosystem to enable secure, compliant, and defensible medical record exchange among participants through efficient management of patient consent information. The illustrative embodiments combine two main functional components, i.e. a blockchain based distributed store and a master patient record index. By integrating these two components, the CIMS ties the granting of patient consent and the release of medical records into an efficient, trusted, and regulation compliant mechanism for governing transactions between patients and health providers.

With regard to the blockchain based component, CIMS uses blockchain technology and the notion of a distributed ledger to establish trust, accountability and proper transparency across the heath care network. The ledger is tamper-proof, append only, and otherwise immutable, and is only updated once a transaction has been validated via a consensus update protocol among authenticated participants. The CIMS uses the ledger to record patient consent and medical record exchange activity, providing a set of consent management applications and protocols for managing consent activity. The record of the patient consent is maintained in a patient consent electronic document or data structure which is enforced using blockchain technology. It should be appreciated that while the illustrative embodiments will be described in the context of blockchain technology being used as a mechanism for ensuring the tamper-proof, append only, and otherwise immutable aspects of the patient consent information and consensus validation, the illustrative embodiments are not limited to such. To the contrary, any now available or later developed technology may be utilized which provides the functionality for allowing the exchange or transfer of patient information only when the exchange or transfer is explicitly allowed by available patient consent information in a patient consent electronic document or data structure, may be utilized without departing from the spirit and scope of the present invention. For example, other technologies that provide “smart contract” based functionality may be used without departing from the spirit and scope of the present invention, where a smart contract is an application that automates the handling of a transaction between parties for the transfer of an asset, such as patient information in the present context.

With regard to the master patient record index (MPRI) component, the CIMS uses the MPRI to enable the exchange of data among health providers once consent has been granted by the patient. The MPRI is continuously updated by recording the information provided by patients and health providers when granting consent and exchanging information. The MPRI maintains records that identify the location of the patient information and the consents associated with this patient information. Patient consent logic may be applied based on the patient consent electronic documents or data structures that specify the entities, e.g., health providers, to which consent has been granted. Thus, only those entities for which a patient consent electronic document or data structure indicates consent has been granted, will be able to be given a record locator that identifies the location of a particular portion of patient information.

Once provided with a record locator from the MPRI, a health provider can directly request patient information from a second provider where the patient information resides, or can use the CIMS as an intermediary data hub which then facilitates and orchestrates the secure information transfer. A set of protocols and applications may be used to enable access to information exchange functions of the CIMS.

Thus, one of the underlying features of the CIMS is the tight interoperation of the providing of patient consent with patient information exchange activity, to provide seamless operation and efficient, auditable record exchange. In particular, the CIMS automatically ensures that any data exchange is backed by a valid consent document, logs data exchanges as they occur, and automatically generates full consent audit logs of every transaction. Likewise, CIMS combines consent management and data exchange actions allowing patients and providers to use their work tools and personal devices to execute on-the-spot consent and information release transactions.

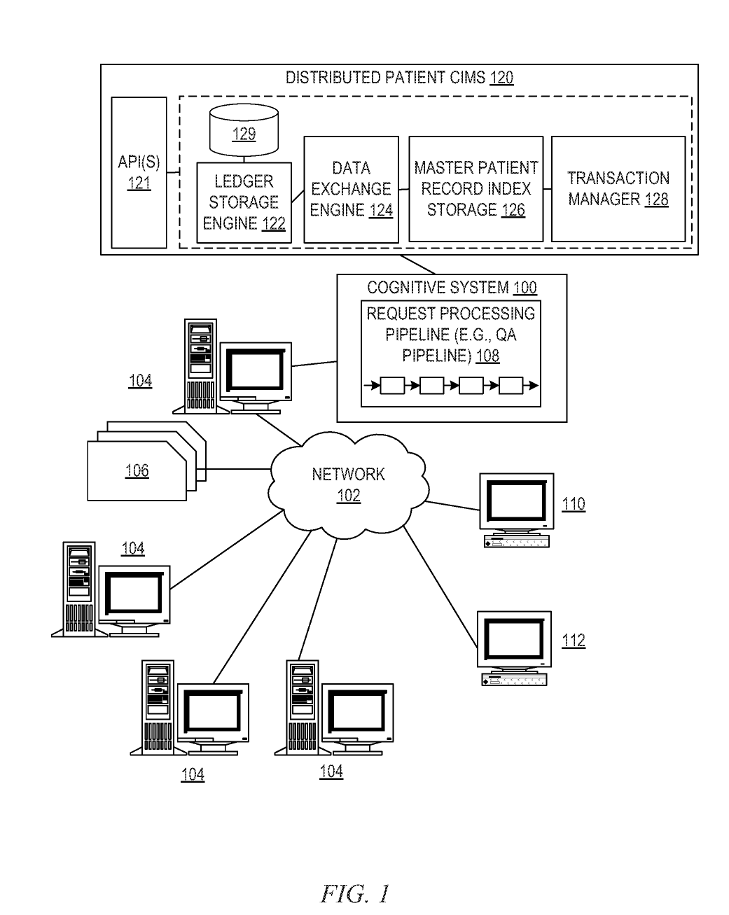

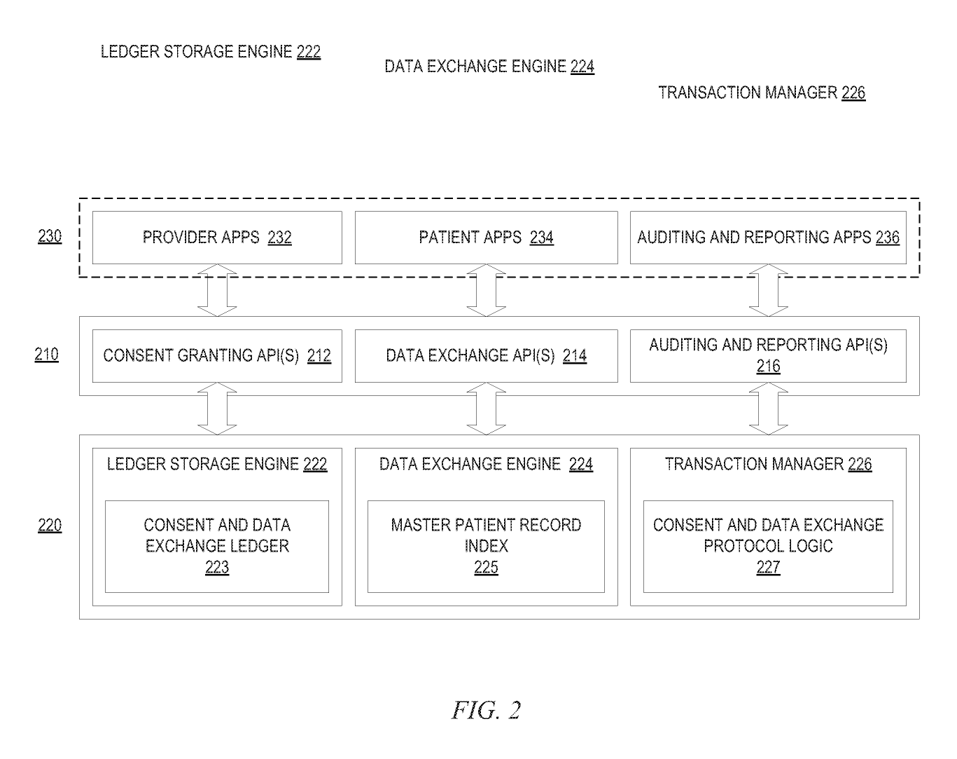

The illustrative embodiments may be utilized in many different types of data processing environments. In order to provide a context for the description of the specific elements and functionality of the illustrative embodiments, FIGS. 1-2 are provided hereafter as example environments in which aspects of the illustrative embodiments may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

One data processing environment in which the aspects of the illustrative embodiments may be implemented is a cognitive data processing system environment in which a cognitive system performs complex operations on structured and/or unstructured, e.g., natural language, content provided in the form of electronic document data structures. For purposes of the description of the illustrative embodiments, it will be assumed that such a cognitive data processing system is augmented with the mechanisms of the illustrative embodiments, and specifically with regard to providing a distributed patient consent and information management system (CIMS) that provides an open and transparent consent management mechanism that allows patients to provide fine grained access to any health related information, to any healthcare solution provider. The health related information, or healthcare data, is not limited to the clinical information held in hospitals and doctors' offices, but includes data held by pharmacies, insurers, genomic testing companies, manufacturers of medical devices, wearable healthcare devices, and the like, which may be collectively referred to as “exogenous data sources,” which may be in some cases much more predictive of health outcomes than traditional clinical data. Thus, the mechanisms of the illustrative embodiments provide an open ecosystem where patients can provide access to any source of information to any potential solution provider.

It should be appreciated that while a cognitive data processing system environment will be used as an example hereafter, the illustrative embodiments may be implemented in other environments as well. Any data processing environment in which entities attempt to access patient information from other entities and the secure consent based distribution of patient information via a CIMS of the illustrative embodiments may be used to facilitate and govern such accesses, may be used without departing from the spirit and scope of the illustrative embodiments.

Using a cognitive data processing system environment as an example, as an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems provide mechanisms for answering questions posed to these cognitive systems using a Question Answering pipeline or system (QA system) and/or process requests which may or may not be posed as natural language questions. The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e. candidate answer, is inferred by the question. This process is repeated for each of the candidate answers until the QA pipeline identifies candidate answers that surface as being significantly stronger than others and thus, generates a final answer, or ranked set of answers, for the input question.

Such QA pipeline mechanisms may be utilized in the manner described above to answer natural language input questions. However, similar mechanisms may be used to handle any input request for information where the request may be parsed as if it were a question and corresponding candidate responses may be generated, scored, ranked, and a final response or output generated. In such a case, the QA pipeline may in fact be a request processing pipeline which processes requests for information. For example, in the case of a cognitive healthcare system which is configured to provide medical treatment recommendations, a request may be submitted that indicates the patient for which a medical treatment recommendation is desired, potentially a diagnosis of the patient, and other relevant information for determining a medical treatment to be recommended for the patient. As part of the input, electronic medical records (EMRs) may be retrieved for the patient and analyzed as part of the corpus that is used to generate, score, and rank the candidate medical treatment recommendations for the identified patient.

The illustrative embodiments set forth herein may work in conjunction with such a cognitive system by providing patient consent based access to patient information via the distributed patient consent and information management system (CIMS). For example, if the request submitted to the cognitive system requires access to patient information, the requestor may need to be authorized via the CIMS mechanisms of the illustrative embodiments before such information is provided to the requestor or a record locator is returned to the requestor for accessing such patient information. Similarly, if the cognitive system is a health information exchange (HIE) system, then HIE system may implement the mechanisms of the CIMS of the illustrative embodiment to govern accesses to patient information in accordance with patient consents.

FIG. 1 depicts a schematic diagram of one illustrative embodiment of a cognitive system 100 implementing a request processing pipeline 108, which in some embodiments may be a question answering (QA) pipeline, in a computer network 102. For purposes of the present description, it will be assumed that the request processing pipeline 108 is implemented as a QA pipeline that operates on structured and/or unstructured requests in the form of input questions. The requests, in accordance with the illustrative embodiments, may be requests for accessing patient information, which may or may not be posed as a natural language question. The cognitive system 100 may implement a medical treatment recommendation system, a health information exchange (HIE) system, or any other system through which access to, and the distribution of, patient information may be controlled using the CIMS mechanisms of the illustrative embodiments.

The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables question processing and answer generation (QA) functionality, or cognitive request processing functionality, for one or more cognitive system users via their respective computing devices 110-112. Other embodiments of the cognitive system 100 may be used with components, systems, sub-systems, and/or devices other than those that are depicted herein.

In the depicted example, the cognitive system 100 is configured to implement a QA pipeline 108 that receive inputs from various sources. For example, the cognitive system 100 receives input from the network 102, a corpus of electronic documents 106, which may include patient information obtained from a variety of different sources, cognitive system users, and/or other data and other possible sources of input. In one embodiment, some or all of the inputs to the cognitive system 100 are routed through the network 102. The various computing devices 104 on the network 102 include access points for content creators and cognitive system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus of data 106 for use as part of a corpus of data with the cognitive system 100. The document includes any file, text, article, or source of data for use in the cognitive system 100. Cognitive system users access the cognitive system 100 via a network connection or an Internet connection to the network 102, and input questions, or requests for information, to the cognitive system 100 that are answered or processed based on the content in the corpus of data 106. In one embodiment, the questions or requests are formed using natural language while in other embodiments the questions/requests may be in a structured format. The cognitive system 100 parses and interprets the question or request via the pipeline 108, and provides a response to the cognitive system user, e.g., cognitive system user 110, containing one or more answers to the question, the requested information, or a response indicating an inability to provide the requested answer/information. In some embodiments, the cognitive system 100 provides a response to users in a ranked list of candidate answers while in other illustrative embodiments, the cognitive system 100 provides a single final answer or a combination of a final answer and ranked listing of other candidate answers. Alternatively, the response may be to provide the information requested or otherwise indicate a lack of consent on the part of the patient to the requestor's patient information request, as discussed hereafter.

The cognitive system 100 implements the pipeline 108 which may comprises a plurality of stages for processing an input question or request and the corpus of data 106. The pipeline 108 generates results, such as an answer or requested information, or a reply indicating a lack of consent, for the input question/request based on the processing of the input question/request and the corpus of data 106.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a pipeline of the IBM Watson™ cognitive system receives an input question or request which it then parses to extract the major features of the question/request, which in turn are then used to formulate queries that are applied to the corpus of data. Based on the application of the queries to the corpus of data, a set of hypotheses, or candidate answers/responses to the input question, are generated by looking across the corpus of data for portions of the corpus of data that have some potential for containing a valuable response to the input question/request. The pipeline of the IBM Watson™ cognitive system then performs deep analysis on the language of the input question and the language used in each of the portions of the corpus of data found during the application of the queries using a variety of reasoning algorithms.

The scores obtained from the various reasoning algorithms are then weighted against a statistical model that summarizes a level of confidence that the QA pipeline of the IBM Watson™ cognitive system has regarding the evidence that the potential response, e.g., candidate answer, is inferred by the question/request. This process is be repeated for each of the candidate answers/responses to generate ranked listing of candidate answers/responses which may then be presented to the user that submitted the input question/request, or from which a final answer/response is selected and presented to the user. More information about the pipeline of the IBM Watson™ cognitive system may be obtained, for example, from the IBM Corporation website, IBM Redbooks, and the like. For example, information about a healthcare domain implementation of the pipeline of the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As noted above, while the input to the cognitive system 100 from a client device may be posed in the form of a natural language question, the illustrative embodiments are not limited to such. Rather, the input question may in fact be formatted or structured as any suitable type of request which may be parsed and analyzed using structured and/or unstructured input analysis, including but not limited to the natural language parsing and analysis mechanisms of a cognitive system such as IBM Watson™, to determine the basis upon which to perform cognitive analysis and providing a result of the cognitive analysis. In the case of a healthcare based cognitive system, this analysis may involve processing patient medical records, medical guidance documentation from one or more corpora, and the like, to provide a healthcare oriented cognitive system result.

In the context of the present invention, cognitive system 100 may provide a cognitive functionality for assisting with healthcare based operations, and in particular with assisting with access to patient information, such as via a healthcare information exchange (HIE), medical treatment recommendation system, or other medical decision support system. For example, depending upon the particular implementation, the healthcare based operations may comprise patient diagnostics, medical treatment recommendation systems, medical practice management systems, personal patient care plan generation and monitoring, patient electronic medical record (EMR) evaluation for various purposes, such as for identifying patients that are suitable for a medical trial or a particular type of medical treatment, or the like. In some cases, the operation may be simply to access particular patient information. Thus, the cognitive system 100 may be a healthcare cognitive system 100 that operates in the medical or healthcare type domains and which may process requests for such healthcare operations via the request processing pipeline 108 input as either structured or unstructured requests, natural language input questions, or the like.

As shown in FIG. 1, the cognitive system 100 is further augmented, in accordance with the mechanisms of the illustrative embodiments, to include or work in conjunction with, a distributed patient consent and information management system (CIMS) 120. The CIMS 120 comprises logic implemented in specialized hardware, software executed on hardware, or any combination of specialized hardware and software executed on hardware, for implementing the functionality directed to enable secure, compliant, and defensible medical record exchange among participants through efficient management of patient consent information. The CIMS 120 combines a tamper-proof record ledger storage engine 122 operating in conjunction with a ledger storage 129, a data exchange engine 124, a master patient record index (MPRI) storage 126, and a transaction manager 128. By integrating these components 122-128, the CIMS ties the granting of patient consent and the release of medical records into an efficient, trusted, and regulation compliant mechanism for governing transactions between patients and health providers.

It should be appreciated that while FIG. 1 shows the CIMS 120 being associated with a single computing device 104, in some illustrative embodiments, CIMS 120 is distributed across a plurality of computing devices, such as the other servers 104 and/or client devices 110-112, such that each computing device implements its own version of CIMS 120 or at least a portion of CIMS 120. In fact, in many implementations using blockchain technology, supporting the CIMS (and the ledger) over a network of devices is important in that it is the network of independent operators in such embodiments that provide a high level of trust.

For example, in some embodiments, the computing devices 104 are part of a blockchain group that each stores the blockchain of transactions in which patient information transactions and consents are involved, in one or more blockchain data structures in storage 129, the transactions of which are handled via the ledger storage engine 122, data exchange engine 124, and transaction manager 128, as described hereafter. One or more of the computing devices 104 may store the master patient record index 124 which identifies the locations of patient information as discussed hereafter. Thus, in some illustrative embodiments, while all of the computing devices may implement elements 122, 124, 126, and 129, a single master server 104 may store the master patient record index (MPRI) that tracks the location of patient information and with which the other computing devices may need to interact in order to perform their operations for granting access to patient information, as described hereafter.

In one illustrative embodiment, the ledger storage engine 122 implements blockchain technology for providing tamper-proof storage of transaction information, or chains of transactions, where the transaction information comprises identification of patient information that was exchanged, the entities exchanging the patient information, and corresponding patient consent information. The blockchain data structures themselves may be stored in the ledger storage 129, for example. It should be appreciated that while a blockchain implementation will be described herein, any tamper-proof transaction storage technology may be utilized, such as any other known or later developed ledger technology.

The data exchange engine 124 comprises logic that controls record transfer and manages a master patient record index stored in the master patient record index (MPRI) storage 126. The transaction manager 128 comprises logic that implements and executes a set of protocols for managing consent and medical record exchange. In addition, a collection of server side APIs 121 may be provided to allow client systems, such as clients 110-112 or other servers 104 operating as clients to one or more other servers 104, to participate in patient information exchanges, while a set of client applications on clients 110-112 (not shown) or other servers 104 allow participants to engage in secure consent and record exchange transactions from their mobile devices and from the systems used in the course of providing medical treatment and other healthcare services.

As noted above, in some illustrative embodiments, distributed patient CIMS 120, also referred to herein as simply “CIMS”, may implement the blockchain distributed ledger technology in order to establish trust, accountability and proper transparency across a heathcare network, e.g., a network of computing devices associated with patients, doctors, pharmacists, hospitals, laboratories, medical facilities, and other providers of healthcare services, equipment, pharmaceuticals, insurance, and products. Rather than having independent ledgers and an individual point to point exchange, a shared replicated permissioned ledger 129 via ledger storage engine 122 allows sharing health data and processes across the healthcare network. The ledgers stored in the ledger storage 129 are implemented as an append-only data structures and thus, provide a distributed system of recording for all patient information transactions in the healthcare network.

A patient information transaction is only recorded in the ledger only after the access request of the transaction is broadcast to an authorized set of participant nodes, or computing devices, in the healthcare network, e.g., the nodes may be servers 104, and a consensus mechanism implemented in the ledger storage engine 122 validates that the request is accurate.

Given that the healthcare network is regulated, the distributed patient CIMS 120 establishes membership before engaging a participant, i.e. a node such as one of the servers 104. Each participant must provide credentials (through a valid authentication mechanism) in order to interact with the distributed healthcare system and thus, distributed patient CIMS. In some cases, as with individual users, such as patients, doctors, pharmacists, laboratory technicians, and the like, biometrics may be used as form of authentications when parties/users registration to the healthcare network and/or CIMS 120. Once granted access to the healthcare network and/or distributed patient CIMS 120, it can be use a secure key in every transaction. Member identity controls the information in the ledger 129 and/or the master patient record index storage 126 that can be viewed and the allowed interactions, based on the member role.

Smart contracts are used to implement any regulations and contractual requirements that apply to any heathcare asset transfer, such as patient information exchanges or transactions. These smart contracts may be implemented by logic in the transaction manager 128. The transaction manager 128 may implement these smart contracts so as to provide governance and control of the transactions involving the exchange of patient information or data, such controlling data segregation, implementing controls over when, in what manner, and for how long an entity may access and/or store the patient information, and the like.

The CIMS 120 maintains, in the master patient record index (MPRI) storage 126, a master list of all known sources and locations of patient data to support the efficient exchange of medical records. The master index for a patient can be kept synchronized with a similar index stored in a personal device, such as a client device 110, owned by the patient to allow easy patient access to consent and management functions. Such a personal device may take the form of a portable computing device (e.g. a smart telephone executing an application), smart appliance, personal computer, computerized health monitoring equipment (e.g., FitBit™), or the like. Patients are provided with a dashboard, via their personal device, with the synopsis of the patient's medical and personal data sources and locations available in CIMS 120, together with the release consent forms granted and the health providers that have received medical records. The master index for a patient stored in the MPRI storage 126 is incrementally built by updates generated by patient and health provider activity facilitated by the CIMS 120. The CIMS 120 learns the location of a patient's medical information when consent is granted by the patient, with the patient information or data location being indicated by the patient to enable release, or as data is exchanged between health providers, e.g., the patient consents to exchanging data from the patient's portable health tracking device 110 to a health provider's computing system 104 and thus, the location of the patient's information is known to be the portable health tracking device 110.

FIG. 2 provides a functional block diagram of a distributed patient CIMS 120 that illustrates the interaction of components in accordance with one illustrative embodiment. As shown in FIG. 2, the primary operational components comprise server side Application Program Interfaces (APIs) 210, the distributed patient CIMS 220, and client side APIs 230. The server side APIs 210 include, but are not limited to, consent granting APIs 212, data exchange APIs 214, and auditing and reporting APIs 216. The distributed patient CIMS 220, which may be CIMS 120 in FIG. 1, for example, comprises a ledger storage engine 222, a data exchange engine 224, and a transaction manager 226. These elements 222, 224, and 226 may be similar to elements 122, 124, and 128, respectively, in FIG. 1. The ledger storage engine 222 provides logic for maintaining and utilizing consent and data exchange ledger 223, which may be implemented as a ledger data structure or set of ledger data structures in storage 129 of FIG. 1, for example. The data exchange engine 224 provides logic that maintains and utilizes the master patient record index 225, which may be implemented as one or more data structures in master patient record index storage 126 in FIG. 1, for example. The transaction manager 226 comprises consent and data exchange protocol logic 227. The client side APIs 230 include, but are not limited to, health provider applications (or “apps”) 232, patient applications 234, and auditing and reporting apps 236.

With the architecture in FIG. 2, the illustrative embodiments provide a trusted mechanism for managing patient consent. The consent and data exchange ledger 223 in the CIMS 220 maintains an immutable record of all consent provided or revoked by an individual patient, which is referred to herein as the “consent log” component of the consent and data exchange ledger 223. The consent log comprises the electronic consent documents or data structures specifying the consent provided or revoked by the individual patient identifying the patient and the entities, e.g., health providers, to which, and from which, consent to exchange patient information has been granted/revoked. The CIMS 220 supports secure transactional updates to this consent and data exchange ledger 223, and thus the consent log, that ensures the information in the consent log of the consent and data exchange ledger 223 can be trusted by all participants in the healthcare network, as well as distributed access by patients, health providers, and other participants.

The following consent protocols or transactions are supported by the logic provided in the ledger storage engine 222 operating on the consent and data exchange ledger data structure(s) 223, and may be accessed via the server consent granting APIs 212, for example. The logic of the ledger storage engine 222 allows for protocols and transactions for granting and revoking consent for a health provider to have access to patient information. This functionality allows a patient to record in the consent and data exchange ledger 223 of the CIMS 220, a consent granting document that specifies that a given health provider is granted access to patient information, such as patient electronic medical records (EMRs), held by a second health provider for a certain period of time, with a set of time and content qualifiers possibly limiting the extend of the grant.

The consent granting exchange may be initiated by the patient, or by one of the health providers. In the first case, after the patient initiates the request to grant consent, and the request to grant consent is broadcast to the set of authorized participant nodes in the healthcare network, or blockchain participants, e.g., servers 104 in FIG. 1. Each participant node device performs its own validation of the request, such as by way of a blockchain consensus protocol implemented by the ledger storage engine 222 logic in each participant node device for example, and then the consent and data exchange ledger 223 is updated assuming all of the participant node devices validate the request. If the validation fails on any of the participant node devices, the update is not performed and the request may be denied. In the case of the request being validated, the health providers receive a notification from the ledger storage engine 222 of the CIMS 220, informing them of the consent having been granted to the specified health provider.

In the second case, where a health provider initiates the request, upon receipt of the health provider request, the ledger storage engine 222 of the CIMS 220 contacts the patient, via a communication transmitted to a patient associated computing or communication device, to inform the patient of the provider request, allowing the patient to grant or deny access to the health provider to patient information held by the other health provider, and then both providers are informed of the consent once the transaction completes. The consent and data exchange ledger 223 is updated accordingly indicating that the patient granted the exchange of patient information.

Likewise, a patient may revoke access to a health provider by recording a consent revocation document in consent and data exchange ledger 223 of the CIMS 220, invalidating previously granted consent. Such revocation may be implemented in a similar manner to that of the granting of consent where again, in the case of patient initiating the request, the request may be validated, such as by way of blockchain protocols for example, and in the case of a health provider initiated request, the patient may be notified to obtain the grant/denial of the change.

In addition to these consent protocols or transactions, the CIMS 220 further provides logic that operates to implement validation and auditing of record release requests. These operations allow a health provider to validate an outstanding request for release of patient information by sending a description of the request to the CIMS 220, which will validate it against existing consent granting documents in the consent and data exchange ledger 223 via the logic of the ledger storage engine 222. This functionality also allows auditing of historical record release activity, checking if a collection of record exchanges performed in the past complied with the patient consent available at the time of the exchange, and the like. Such functionality of the ledger storage engine 222 may be access via the server side auditing and reporting APIs 216, for example.

Moreover, the CIMS 220 provides logic for providing consent activity reporting, which again may be access via the auditing and reporting APIs 216. For example, a patient may request a report of consent that the patient has granted or revoked, as well as any inquiries made by health providers. A health provider may request all consent provided by a patient involving records held by that particular provider (both received and sent). Reporting functions allow auditors and regulators to review all consent grants and data releases for each patient and health provider.

The information present in the consent transactions handled by the ledger storage engine 222 provide information regarding the locations, e.g., which computing devices, of the various portions of patient information subject to the consents recorded in the consent and data exchange ledger 223. Thus, as consent transactions, and corresponding patient information data exchanges, occur, the data exchange engine 224 logs the locations of the patient information in the master patient record index (MPRI) 225 for the patient. This MPRI 225 may then be used by health providers when requesting particular patient information about a patient so as to locate where the patient resides and correlate that information with consent information in the consent and data exchange ledger 223 to determine if consents are in place from the patient for the health provider requesting access to the patient information to obtain that patient information from the health provider that holds or stores that patient information. Moreover, such information may be used to populate notifications and requests sent to the patient to inform them of what health provider is requesting the patient information, what patient information is being requested, and what health provider would be providing the patient information, so that the patient can make an informed decision as to whether to grant (give consent) or deny (revoke or deny consent) the transaction to exchange the patient information.

The CIMS 220 also facilitates the compliant exchange of medical records, such as via data exchange APIs 214 and the consent and data exchange protocol logic 227 implemented by the transaction manager 226. The consent and data exchange protocol logic 227 provides a mechanism for validation, information exchange, logging and auditing data exchange activities. In particular, the protocol logic 227 records patient information release requests, sent by a health provider, which are matched against the consent record of the patient stored in the consent and data exchange ledger 223. If consent is available, e.g., already indicated as granted it he consent record, the request is approved and the exchange of the patient information is initiated. If not, a notification and consent request is sent to the patient, via the patient's associated computing device, who can initiate the consent granting protocol and permit the patient information data exchange to continue. In some cases, requests may claim the release is covered by “implicit consent”, which is then recorded and the patient is informed.

The exchange of patient information, such as EMRs, or portions of EMRs, may be enabled by two alternative mechanisms. In one illustrative embodiment, a record locator from the master patient record index 225 of the data exchange engine 224 in the CIMS 220 is sent to the requesting health provider. The record locator enables retrieval of the information from the releasing health provider, e.g., computing system of a health provider where the patient information is stored. The records are directly exchanged between the two health provider computing systems without the need for mediation by the CIMS 220. Record locators not available in the master patient record index 225 of the CIMS 220 may be created by requesting patient input to identify the location of the patient information, or may be automatically generated from information identified in consent transactions logged by the ledger storage engine 22 as part of the tracking and recording of consent based data exchanges and storage of the ledger 223.

In an alternative approach, the CIMS 220 may mediate the patient information exchange by acting as a secure data hub that receives encrypted patient information, e.g., EMRs, portions of EMRs, or other patient information data records, from one health provider computing system and sends the encrypted patient information to the other health provider computing system.

Patient information exchange activity is recorded in the consent and data exchange ledger 223 of the CIMS 220, again as part of this tamper-proof and immutable ledger data structure. If the exchange used the CIMS 220 as a data exchange hub, the patient information release between the two health providers is automatically logged in the consent and data exchange ledger 223 by the ledger storage engine 222. If instead the exchange used record locators provided by the data exchange engine 224 based on the master patient record index 225, the releasing and receiving health providers log, into the CIMS 220, the release and receipt of the patient information, including the description of information being released and a unique hash value that is the fingerprint of the patient information or data being released, or in some illustrative embodiments a hash of the blockchain itself. A cryptographic hash function may be utilized which is a mathematical algorithm that maps data of arbitrary size to a bit string of a fixed size (a hash function) which is designed to also be one-way function, that is, a function which is infeasible to invert.

For information and auditing purposes, patients and health providers can request reports of patient information exchange activity and the consent information that supports such exchanges via the auditing and reporting APIs 216.

It should be appreciated that in the above description, the operations of entities outside of the CIMS 220 for requesting and providing patient information may be performed via client side APIs or applications 230. Thus, health providers may perform the various operations described above via their associated provider apps 232 while patients may utilize patient apps 234 to perform their various operations discussed above. These APIs or applications 230 are software instructions executed by corresponding computing devices, with the exchange of data or information between such APIs or applications 230 with the CIMS 220 being facilitated by one or more data networks, generically illustrated in FIG. 2 as the thick double arrows.

Thus, from the above discussion it can be seen that the mechanism of the illustrative embodiments provide a more secure and auditable solution for controlling access to patient information, which instills greater trust by health providers and patients. The tamper-proof and immutable ledgers 223, such as may be generated using blockchain technology for example, are the system of record for all health care based patient information transactions inside the health blockchain network. Health participants consent to verified health related transactions. Smart contracts are used to capture health related compliances and conditional logic requirements. Transactions may be embedded into distributed databases and self-executed with each transaction. Privacy is achieved by ensuring each member has the proper level of viability, and health related transactions are maintained secure.

Moreover, greater control of patient information is provided to the patient. CIMS 220 allows patient information to be delivered to health providers at the right level of granularity and relevance by allowing for the association of consent with individual portions of patient information and that consent being tracked by the consent and data exchange ledger 223. The transparency made possible by the maintaining of the consent and date exchange ledge 223 results in greater auditability, which can be used to verify chain of custody and appropriate health data handling by health providers. Moreover, secure connection to the end servers may be implemented with the mechanisms of the illustrative embodiments, such as by using technologies such as IBM ZTIC, which may be used to provide data transactions outside of the blockchain for large data transfers, such as MRI images being provided to a health provider. Furthermore, the illustrative embodiments may operate in conjunction with cognitive computing, which may be used to analyze authorized access, for example.

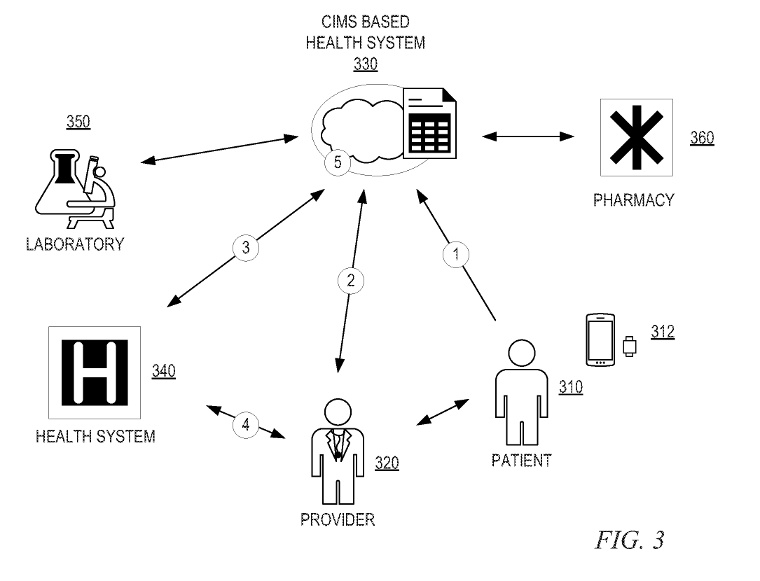

FIGS. 3-5 provide example scenarios to illustrate interactions between patients and health providers that are facilitated by the mechanisms of the illustrative embodiments. FIG. 3 illustrates a scenario in which the CIMS mechanisms provide protocols and applications to seamlessly authorize and execute on-demand exchange of patient information, e.g., EMRs, in real-time while ensuring compliance and full auditability. In the depicted example, the patient 310 has a doctor visit with the doctor (provider) 320. During the doctor visit, the patient 310 utilizes a client side application on the patient's mobile device 312, which is depicted as either a mobile application on a smart phone, a wearable health monitoring device, or the like. The client side application provides a dashboard through which the patient performs a lookup of the patient's EMRs in the master patient record index (MPRI) and initiates a request to exchange that information with the doctor's computing system, i.e. the patient grants consent to the doctor (provider) 320 (step 1 in FIG. 3). The lookup and request operations are performed using data exchanges with the CIMS based health system 330. As discussed previously, this CIMS based health system 330 may be a cognitive healthcare system, a health information exchange (HIE) system, or any other system that facilitates the exchange of patient information between entities using the CIMS based mechanisms of the illustrative embodiments.

The doctor's computing system, such as an app executing on a mobile device, a computing system, or the like, associated with the doctor (provider) 320, is notified of the consent given by the patient to access patient information from the MPRI. The doctor's app may then verify the information to be shared and requests the patient's EMRs from the CIMS based health system 330 (step 2 in FIG. 3). The CIMS mechanisms of the illustrative embodiments, implemented in the CIMS based health system 330, verifies the request from the doctor's app is valid and forwards the request to the health system 340 where the patient information is located, as indicated by the MPRI of the CIMS based health system 330 (step 3 in FIG. 3). The health system 340 may then further verify consent is available and transmit the patient EMRs to the doctor (provider) computing system 320 (step 4 in FIG. 3). The CIMS based health system 330 may log all patient information and consent exchange activity in the ledger (step 5 in FIG. 3). It should be noted that while FIG. 3 is described with the patient initiating the exchange of patient information, the exchange may likewise be initiated by the health provider, e.g., doctor 320, and requesting patient 310 to provide consent via their app on mobile device 312.

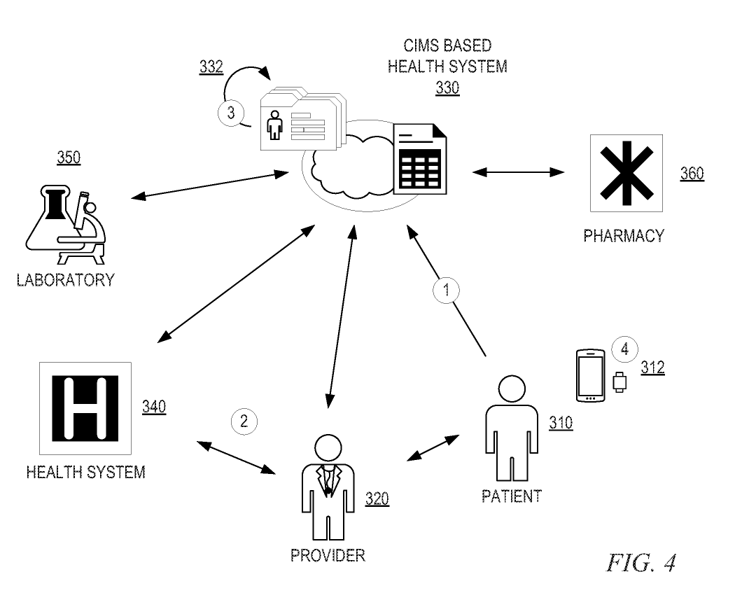

FIG. 4 illustrates a scenario in which the CIMS mechanisms continuously build a master patient record index (MPRI) by learning and updating the index as patients and health providers exchange patient information consents and release transactions. In the depicted scenario, the patient 310 grants consent for releasing patient information and provides location information, e.g., identifying a health provider that stores or holds the patient information (referred to also as a “releasing institution”), e.g., health system 340 in FIG. 4, and patient information characteristics (step 1 in FIG. 4). For example, this information may comprise a data structure specifying the health provider to which consent is granted, the terms of the consent, e.g., time limitations, date limitations, usage limitations, etc., the portion of the patient information to which the consent applies, and the location where that portion of patient information resides, such as a name, address, storage location, or the like, of the health provider that will act as the source of the portion of patient information for the transaction. The CIMS based health system 330 records the successful transaction, i.e. release of the patient information to the provider 320, and validates the accuracy of the location information, e.g., through the use of metadata of the blockchain or a hash of the metadata, where the metadata is the index where the data resides. The CIMS based health system 330 updates the MPRI 332 with the new record locator for the location of the patient information (step 3 in FIG. 4). Then next time the patient 310 grants consent, the new location is visible in the patient's app on their mobile device 312 so that the patient, through the available dashboard of the app, can select that patient information and provide consent to other health providers to access that patient information (step 4 in FIG. 4). Moreover, health providers can directly update the MPRI with new information about the location of the patient information, e.g., EMRs, as the new patient information is generated.

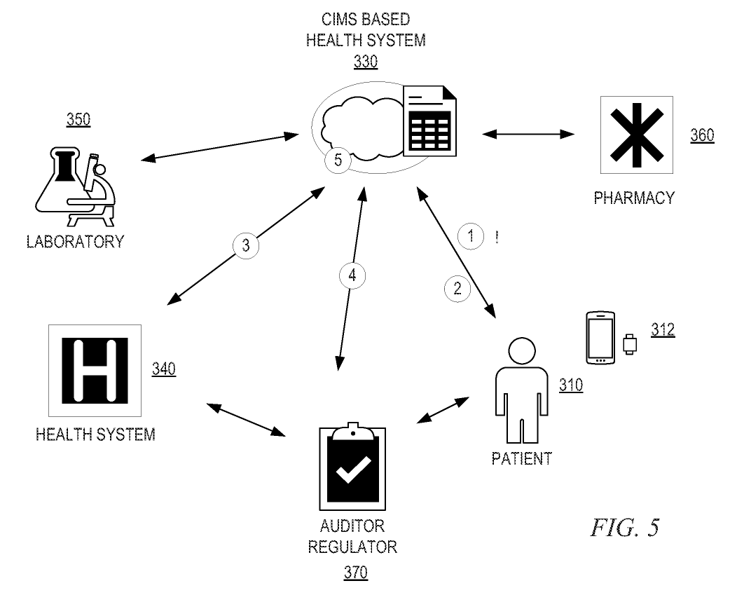

FIG. 5 illustrates a scenario in which the CIMS mechanisms of the illustrative embodiments provide an immutable comprehensive record with location of known patient data, all consent grants, and all records of patient information release activity, ensuring full visibility by all parties and auditability. As shown in FIG. 5, a patient 310 can monitor in real time all activity related to his/her individual patient information via an app and dashboard available on the patient's mobile device 312 which interacts with the CIMS based health system 330 to obtain such information (step 1 in FIG. 5). The patient may also retrieve comprehensive reports with all patient information, e.g., EMR, transfers by a health provider, all granted consent documents or data structures, a summary of all locations where their personal patient information resides, and the like, via the app and dashboard (step 2 in FIG. 5).

A health system 340 may also monitor and report on patient information exchange activity and compliance status (step 3 in FIG. 5). Auditors and regulators can easily retrieve comprehensive reports of patient information release and consent so as to ensure health provider compliance with regulations (step 4 in FIG. 5).

As noted above, the mechanisms of the illustrative embodiments are rooted in the computer technology arts and are implemented using logic present in such computing or data processing systems. These computing or data processing systems are specifically configured, either through hardware, software, or a combination of hardware and software, to implement the various operations described above. As such, FIG. 2 is provided as an example of one type of data processing system in which aspects of the present invention may be implemented. Many other types of data processing systems may be likewise configured to specifically implement the mechanisms of the illustrative embodiments.

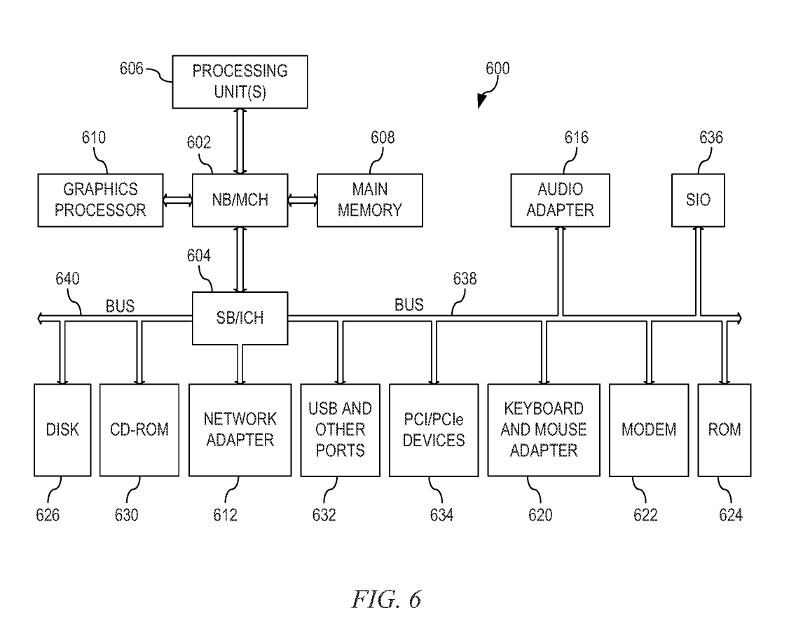

FIG. 6 is a block diagram of an example data processing system in which aspects of the illustrative embodiments are implemented. Data processing system 600 is an example of a computer, such as server 604 or client 610 in FIG. 6, in which computer usable code or instructions implementing the processes for illustrative embodiments of the present invention are located. In one illustrative embodiment, FIG. 6 represents a server computing device, such as a server 604, which implements a cognitive system 100 and request processing pipeline 108 augmented to include, or operate in conjunction with, the CIMS mechanisms of one or more of the illustrative embodiments described above. Alternatively, in some illustrative embodiments, the data processing system 600 may implement the CIMS mechanisms of one or more of the illustrative embodiments without implementing a cognitive system.

In the depicted example, data processing system 600 employs a hub architecture including North Bridge and Memory Controller Hub (NB/MCH) 602 and South Bridge and Input/Output (I/O) Controller Hub (SB/ICH) 204. Processing unit 606, main memory 608, and graphics processor 610 are connected to NB/MCH 602. Graphics processor 610 is connected to NB/MCH 202 through an accelerated graphics port (AGP).

In the depicted example, local area network (LAN) adapter 612 connects to SB/ICH 604. Audio adapter 616, keyboard and mouse adapter 620, modem 622, read only memory (ROM) 624, hard disk drive (HDD) 626, CD-ROM drive 630, universal serial bus (USB) ports and other communication ports 632, and PCI/PCIe devices 634 connect to SB/ICH 604 through bus 638 and bus 640. PCI/PCIe devices may include, for example, Ethernet adapters, add-in cards, and PC cards for notebook computers. PCI uses a card bus controller, while PCIe does not. ROM 624 may be, for example, a flash basic input/output system (BIOS).

HDD 626 and CD-ROM drive 630 connect to SB/ICH 604 through bus 640. HDD 626 and CD-ROM drive 630 may use, for example, an integrated drive electronics (IDE) or serial advanced technology attachment (SATA) interface. Super I/O (SIO) device 636 is connected to SB/ICH 604.

An operating system runs on processing unit 606. The operating system coordinates and provides control of various components within the data processing system 600 in FIG. 6. As a client, the operating system is a commercially available operating system such as Microsoft® Windows 10®. An object-oriented programming system, such as the Java™ programming system, may run in conjunction with the operating system and provides calls to the operating system from Java™ programs or applications executing on data processing system 600.

As a server, data processing system 600 may be, for example, an IBM® eServer™ System p® computer system, running the Advanced Interactive Executive (AIX®) operating system or the LINTJX® operating system. Data processing system 600 may be a symmetric multiprocessor (SMP) system including a plurality of processors in processing unit 606. Alternatively, a single processor system may be employed.

Instructions for the operating system, the object-oriented programming system, and applications or programs are located on storage devices, such as HDD 626, and are loaded into main memory 608 for execution by processing unit 606. The processes for illustrative embodiments of the present invention are performed by processing unit 606 using computer usable program code, which is located in a memory such as, for example, main memory 608, ROM 624, or in one or more peripheral devices 626 and 630, for example.

A bus system, such as bus 638 or bus 640 as shown in FIG. 6, is comprised of one or more buses. Of course, the bus system may be implemented using any type of communication fabric or architecture that provides for a transfer of data between different components or devices attached to the fabric or architecture. A communication unit, such as modem 622 or network adapter 612 of FIG. 6, includes one or more devices used to transmit and receive data. A memory may be, for example, main memory 608, ROM 624, or a cache such as found in NB/MCH 602 in FIG. 6.

Those of ordinary skill in the art will appreciate that the hardware depicted in FIGS. 1 and 6, as well as the other figures, may vary depending on the implementation. Other internal hardware or peripheral devices, such as flash memory, equivalent non-volatile memory, or optical disk drives and the like, may be used in addition to or in place of the hardware depicted in FIGS. 1 and 6. Also, the processes of the illustrative embodiments may be applied to a multiprocessor data processing system, other than the SMP system mentioned previously, without departing from the spirit and scope of the present invention.

Moreover, the data processing system 600 may take the form of any of a number of different data processing systems including client computing devices, server computing devices, a tablet computer, laptop computer, telephone or other communication device, a personal digital assistant (PDA), or the like. In some illustrative examples, data processing system 600 may be a portable computing device that is configured with flash memory to provide non-volatile memory for storing operating system files and/or user-generated data, for example. Essentially, data processing system 600 may be any known or later developed data processing system without architectural limitation.

Thus, the illustrative embodiments provide computer implemented mechanisms for providing decentralized consent management with consent validation from all parties involved. The illustrative embodiments further provide decentralized data/information sharing management, based on the consent management and consent validation. Moreover, the illustrative embodiments provide decentralized data/information sharing management via the system of recording patient information location in the master patient information index as well as correlation with consent information.

The mechanisms of the illustrative embodiments further provide decentralized consent management and decentralized patient data/information sharing where policies and procedures are updated at once without relying on updates to information technology systems of individual health providers. In addition, the mechanisms of the illustrative embodiments provide a distributed patient consent and information management system (CIMS) that streamlines the end to end process from consent management to integrated medical information hub to improve the patient and heath enterprise participant experience. The CIMS mechanisms also provide consistent information to all authorized health care parties

In some illustrative embodiments, the mechanisms of the illustrative embodiments provide a decentralized biomedical/healthcare ecosystem, including participants from life sciences, healthcare providers, healthcare payers, auditors, and the like, with a new method for participants to manage and validate patient consent. In such an ecosystem, the patient may provide consent to access the patient's health data by selected participants in the biomedical/healthcare ecosystem or enterprise, and the consent may be made available to participants using a decentralized blockchain based mechanism. The consent may be made available to the participants with consent validation and patients may be given full transparency and control over access to their consents of patient data/information exchanges. In this decentralized biomedical/healthcare ecosystem, selected participants may be provided with the patient data/information based on the patient's consent using a decentralized blockchain based mechanism.

In some embodiments, consent is decentralized without the need of centralized authority. In some embodiments, a centralized storage of patient information location is utilized, which may be enabled and made retrievable by a trusted network implementation. In some embodiments, consent for accessing the patient data/information can be enabled by dynamic permission or revocation of consent via a consent request. The granting/revocation of consent may be tracked in an immutable tamper-proof audit log.

In some embodiments, smart contracts are implemented which provide network wide access control to the patient information/data while enforcing mandated policies without relying on the information technology systems of individual health providers. In some illustrative embodiments, a consent network is provided where requests may be exchanged and managed in a manner where access control changes are performed in a one-step procedure using smart contracts and blockchain technology, without communication with individual participants, e.g., individual health providers.

In some illustrative embodiments, a mechanisms are provided for a decentralized biomedical/healthcare ecosystem including participants from life sciences, healthcare providers, healthcare payers, auditors, in which operations for patient mediated health data exchange are performed and where patient consent is bound to patient information or data. In such an ecosystem, the patient may provide fine grain consent to access the patient's information or data by selected participants in the biomedical/healthcare ecosystem. The patient consent may be made available to the participants using a decentralized blockchain based mechanism. Selected participants may share the patient information/data when appropriate consents are given, using a decentralized and smart contract blockchain based mechanism. Selected participants may also reclassify non-sensitive patient information/data into sensitive patient information/data using certification blockchain based mechanisms. For example, a patient may visit a doctor where the patient information for the type of visit is generally considered non-sensitive, but the patient may reveal some sensitive patient information that is recorded and that data may be tagged, such as through the patient information separation mechanisms described above, to be associated with an indicator of sensitive patient information and thus, requiring consent for access.

The patient data may be exchanged among the participants in a way to improve patient outcome while complying with the patient's consent. Furthermore, in some illustrative embodiments, the patient information/data may be de-identified, anonymized, or obfuscated prior to patient information/data exchange among the participants, such as by using tags or the like, and the blockchain based mechanism. For example, as noted above, if a health provider is given fine grain access to a portion of patient information, de-identification mechanisms may be used to remove other portions of patient information that the health provider does not have consent to access. The de-identified patient information is stored by the health provider and a corresponding locator is associated with the de-identified patient information, as well as consent information via the ledger, such that the de-identified patient information may be reused without having to go through de-identification operations repeatedly.

In some illustrative embodiments, the consent includes data segmentation enabling categorization of patient information, or health data, into segments, allowing partial sharing of patient information/data. Moreover, in some illustrative embodiments, through the mechanisms of fine grained patient information/data consent management of the illustrative embodiments, selected private data and/or medication information may be made available to participants to improve heath outcome or to manage cost. Selected participants may tag the patient information/data (new and sensitive data) as protected when it leaves that participants computing system, even when the point of care is at locations where data is not considered “sensitive” and usually categorized as non-sensitive.

In some illustrative embodiments, selected segments of patient information/data may be classified as private to selected participants using the consent based mechanisms of the illustrative embodiments. Such functionality may be enabled by a blockchain mechanism of the CIMS that provides an automated, e.g., smart contract, policy to tag protected patient information/data in an auditable network, without the need to change current systems or impact performance time. Moreover, patients may authorize the use of their de-identified, anonymized, or obfuscated patient information/data and its reuse by other participants (e.g. research facilities) via the mechanisms of the illustrative embodiments. This de-identification of the patient information/data may comprise patient personal identifiers or uniquely identifiable information in the patient information/data being removed from the patient information/data at the point of use. In some cases, the participant (e.g., research clinician) may remove the identification portion of the patient information/data and then tag that portion as “no longer identified”. When other participants have obtained the patient's consents, they may reuse de-identified patient information/data without having to go over this same process.

In some illustrative embodiments, participant data certification can be done once and registered in a tamper proof manner on blockchain enabling free exchange of de-identified data without manual intervention by individual institutions. Moreover, in the some illustrative embodiments, participant data and its consents may be coupled using a blockchain based mechanism.

Furthermore, in some illustrative embodiments, the master patient record index (MPRI) can be used to maintain the master list, or multiple lists, of all sources and locations where the patient information, which may include patient health and fitness data, is located or sourced. Moreover, this information may be continually learned from the patients and the participants based on patient information consents and release activity.

In some illustrative embodiments, the CIMS mechanisms enable a secure medical information exchange hub that controls and secures exchange of medical, health, pharmacy and fitness information, also referred to herein as patient information, ensuring compliance and auditability of patient information releases. In some illustrative embodiments, a decentralized system for consent management and data information sharing among participants and patients is provided where policies and procedures are updated dynamically without relying on updates to information technology systems of individual providers. These policies may be updated based on patient consent and data dissemination, without the need for the participant (individual institutions) to update their information technology systems. These policies may be translated into rules enforced by smart contracts ensuring that system wide changes can be made once instead of relying on updates to information technology systems of individual providers.

Moreover, the CIMS mechanisms of the illustrative embodiments may continually learn these policies from patient and provider based patient information release activities, and based on the proper authorization using blockchain based methods. Furthermore, the mechanisms of the illustrative embodiments may enable value driven health care solutions using APIs and blockchain based mechanisms.

In some illustrative embodiments, participants may have the proper privilege to perform “break the glass” access to patient information, which can be enabled by using blockchain master key mechanism based methods. What is meant by “break the glass” or “break glass” access is that a health provider, who does not have access privileges or prior consent from the patient to certain patient information, may need to gain access to this information in cases of emergency so as to properly treat the patient. For example, a doctor who is about to treat a trauma patient in an emergency room may need to obtain access to the patient's information for treatment. There are legal (e.g., HIPPA) processes for determining who at the medical facility can take action to obtain access to such patient information under these circumstances, as well as how the information may be used and how access is tracked. The mechanisms of the illustrative embodiments facilitate this process and provides an audit trail using the ledger mechanisms. For example, in a blockchain implementation, the master key that allows access to transaction records and consents and patient information of these transaction records may be used to obtain access to the patient information on an emergency basis.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for executing patient information transactions based on a security protected transaction ledger, comprising:
storing, by the data processing system, in a ledger storage system, for each patient, a history of patient consents associated with patient transactions in a healthcare network, comprising patient consent data structures associated with the patient information transferred between participants as part of the transaction;
storing, by the data processing system, a master patient record index (MPRI) for each of the patients, wherein the MPRI stores record locators identifying locations of portions of patient information for the patient on different computing devices associated with different health providers;
executing, by a transaction manager of the data processing system, a transaction to grant access to a portion of a patient's information based on consent information stored in the ledger storage system and record locators in the MPRI; and
updating, by a ledger storage engine of the data processing system, the history of transactions based on the execution of the transaction.

2. The method of claim 1, wherein the ledger storage system implements a blockchain methodology for storing the history of transactions.

3. The method of claim 1, wherein the ledger storage system stores transactions that comprise consent information associated with patient information that either grants access to the patient information to a health provider, denies access to the patient information to the health provider, or revokes a previous grant of access to the patient information to the health provider.

4. The method of claim 1, further comprising:
receiving a request from a patient computing device to view patient information and consent information associated with the patient information; and
outputting the patient information for the patient in association with consent information associated with the patient information to the patient computing device for review and/or modification.

5. The method of claim 1, wherein executing, by a transaction manager of the data processing system, a transaction to grant access to a portion of a patient's information based on consent information stored in the ledger storage system and record locators in the MPRI comprises:
distributing, to a plurality of node devices of a validation network, a request for validation of the transaction; and
receiving a response from the plurality of node devices indicating whether or not the transaction is validated, wherein the transaction is executed by the transaction manager only if the response from the plurality of node devices indicates that the transaction is validated.

6. The method of claim 5, wherein receiving a response from the plurality of node devices indicating whether or not the transaction is validated comprises:
performing, at each node device in the plurality of node devices, a validation of the transaction based on a blockchain consensus protocol; and
generating a response from the plurality of node devices based on results of validation of the transaction by each of the node devices, wherein the response from the plurality of node devices is a denial of the request if any one of the node devices does not indicate the transaction to be validated.

7. The method of claim 5, wherein the transaction is executed by the transaction manager at least by:
retrieving a record locator from the MPRI, that identifies a location of the portion of the patient's information on a first participant device; and
providing the record locator to a second participant device as part of the transaction of patient information to facilitate performance of the transaction by the second participant device.

8. The method of claim 7, wherein the first participant device is a wearable health monitoring device associated with the patient.

9. The method of claim 1, wherein executing, by a transaction manager of the data processing system, a transaction to grant access to a portion of a patient's information based on consent information stored in the ledger storage system and record locators in the MPRI comprises performing a de-identification operation on the portion of the patient's information to remove any patient identifiers from the patient information prior to executing the transaction.

10. The method of claim 1, wherein updating the history of transactions based on the execution of the transaction comprises:
logging the transaction in an append only ledger record of a ledger storage;
logging, in the ledger storage, a consent log, wherein the consent log comprises immutable consent records, and wherein the consent records comprise consent documents or data structures indicating consent provided or revoked by the patient, and the particular entities to which consent has been provided or revoked by the patient, for accessing the portion of the patient's information; and
generating a full consent audit log of the transaction based on the append only ledger record and consent log.

11. A computer program product comprising a computer readable storage medium having a computer readable program stored therein, wherein the computer readable program, when executed on a computing device, causes the computing device to:
store, in a ledger storage system, for each patient, a history of patient consents associated with patient transactions in a healthcare network, comprising patient consent data structures associated with the patient information transferred between participants as part of the transaction;
store a master patient record index (MPRI) for each of the patients, wherein the MPRI stores record locators identifying locations of portions of patient information for the patient on different computing devices associated with different health providers;
execute, by a transaction manager, a transaction to grant access to a portion of a patient's information based on consent information stored in the ledger storage system and record locators in the MPRI; and
update, by a ledger storage engine, the history of transactions based on the execution of the transaction.

12. The computer program product of claim 11, wherein the ledger storage system implements a blockchain methodology for storing the history of transactions.

13. The computer program product of claim 11, wherein the ledger storage system stores transactions that comprise consent information associated with patient information that either grants access to the patient information to a health provider, denies access to the patient information to the health provider, or revokes a previous grant of access to the patient information to the health provider.

14. The computer program product of claim 11, wherein the computer readable program further causes the computing device to:
receive a request from a patient computing device to view patient information and consent information associated with the patient information; and
output the patient information for the patient in association with consent information associated with the patient information such that the patient is able to view the patient information and consent information via the patient computing device.

15. The computer program product of claim 11, wherein the computer readable program further causes the computing device to execute the transaction to grant access to a portion of a patient's information based on consent information stored in the ledger storage system and record locators in the MPRI at least by:
distributing, to a plurality of node devices of a validation network, a request for validation of the transaction; and
receiving a response from the plurality of node devices indicating whether or not the transaction is validated, wherein the transaction is executed by the transaction manager only if the response from the plurality of node devices indicates that the transaction is validated.

16. The computer program product of claim 15, wherein the computer readable program further causes the computing device to receive a response from the plurality of node devices indicating whether or not the transaction is validated at least by:
performing, at each node device in the plurality of node devices, a validation of the transaction based on a blockchain consensus protocol; and
generating a response from the plurality of node devices based on results of validation of the transaction by each of the node devices, wherein the response from the plurality of node devices is a denial of the request if any one of the node devices does not indicate the transaction to be validated.

17. The computer program product of claim 15, wherein the computer readable program further causes the computing device to execute the transaction at least by:
retrieving a record locator from the MPRL that identifies a location of the portion of the patient's information on a first participant device; and
providing the record locator to a second participant device as part of the transaction of patient information to facilitate performance of the transaction by the second participant device.

18. The computer program product of claim 11, wherein the computer readable program further causes the computing device to execute the transaction to grant access to a portion of a patient's information based on consent information stored in the ledger storage system and record locators in the MPRI at least by performing a de-identification operation on the portion of the patient's information to remove any patient identifiers from the patient information prior to executing the transaction.

19. The computer program product of claim 11, wherein the computer readable program further causes the computing device to update the history of transactions based on the execution of the transaction at least by:
logging the transaction in an append only ledger record of a ledger storage;
logging, in the ledger storage, a consent log, wherein the consent log comprises immutable consent records, and wherein the consent records comprise consent documents or data structures indicating consent provided or revoked by the patient, and the particular entities to which consent has been provided or revoked by the patient, for accessing the portion of the patient's information; and
generating a full consent audit log of the transaction based on the append only ledger record and consent log.

20. An apparatus comprising:
a processor; and
a memory coupled to the processor, wherein the memory comprises instructions which, when executed by the processor, cause the processor to:
store, in a ledger storage system, for each patient, a history of patient consents associated with patient transactions in a healthcare network, comprising patient consent data structures associated with the patient information transferred between participants as part of the transaction;
store a master patient record index (MPRI) for each of the patients, wherein the MPRI stores record locators identifying locations of portions of patient information for the patient on different computing devices associated with different health providers;
execute, by a transaction manager, a transaction to grant access to a portion of a patient's information based on consent information stored in the ledger storage system and record locators in the MPRI; and
update, by a ledger storage engine, the history of transactions based on the execution of the transaction.
